(19) United States
(12) Patent Application Publication
(10) Pub. No.: US 2016/0292997 A1
(43) Pub. Date: Oct. 6, 2016

(54) Traffic Hazard Warning System and Device

(71) Applicant: Alexander Paul Milne, Romsey, Victoria (AU)

(72) Inventor: Alexander Paul Milne, Romsey, Victoria (AU)

(21) Appl. No.: 15/026,907

(22) PCT Filed: Oct. 3, 2014
(86) PCT No.: PCT/AU2014/050267

§ 371 Date: Apr. 1, 2016

(30) Foreign Application Priority Data
Oct. 3, 2013 (AU) 2013903825

(51) Int. Cl. G08G 1/005; H04W 4/00; G08B 5/22; G08B 6/00; G08B 3/10; G08G 1/16; H04W 4/04

(52) U.S. Cl. CPC G08G 1/005; G08G 1/166; H04W 4/008; H04W 4/046; G08B 6/00; G08B 3/1016; G08B 5/224

(57) ABSTRACT

A system for warning an individual of a potential traffic hazard includes a radio signal transmitter configured to transmit a warning signal, and radio signal receiver configured to receive the warning signal. The system also includes at least one of the following elements responsive to reception of the warning signal by the radio signal receiver: (a) sound transducer to deliver audio to the individual and sound altering device, which alters the audio delivered to the individual such that the individual is made aware of the traffic hazard; (b) a visual media display to deliver a visual medium to the individual, and a visual media altering device, which alters the visual medium such that the individual is made aware of the traffic hazard; or (c) a tactile stimulus device to deliver a tactile stimulus such that the individual is made aware of the traffic hazard to the individual.

### FIELD OF THE INVENTION

The present invention relates to the area of traffic safety. In particular, the invention relates to electronic systems and devices for warning an individual of a potential traffic hazard in their immediate environment.

### BACKGROUND TO THE INVENTION

Mobile audio players are now small in size and inexpensive allowing many individuals to listen to music while walking, exercising and even driving. Moreover, the emergence of the smart phones allows for increasing numbers of individuals to play games and watch videos when out and about. Many cars these days are also fitted with sophisticated digital sound systems.

While these modem contrivances undoubtedly provide pleasure, there is an increasing danger that pedestrians and drivers become distracted by music, games and telephone conversations and often fail to notice the surrounding traffic situation. In many situations the individual simply cannot hear the surrounding traffic due to excessive volume of music being played. This is exacerbated where “in-ear” headphones are used which completely seal the ear canal.

A report by researchers at the Children's Hospital of the University of Maryland disclosed that the number of pedestrians wearing headphones when involved in traffic accidents tripled over a six year period (R. Lichenstein, D. C. Smith, J. L. Ambrose and L. A. Moody, Headphone use and pedestrian injury and death in the United States: 2004-2011, Injury Prevention published online (2012)). According to that report, the number of casualties was 16 in 2004 and 2005, increasing to 47 in 2010 and 2011. All victims were injured by a car, train, or other vehicle while wearing headphones. The researchers postulated that (in addition to simply interfering with normal hearing) wearing headphones is dangerous because it slows down and limits visual and auditory reactions to the surroundings.

There have been a number of attempts in the prior art to address this problem. One approach involves the use of a microphone to receive mixing ambient sounds related to potential traffic hazards with music. Such methods significantly diminish the listening experience given the constant interference with the audio track. These methods are prone to false alarms where an ambient sound is not related to a traffic hazard, and also to missing important warnings especially where the ambient noise is complex.

Other methods rely on visual stimuli. For example, an emergency vehicle may emit a long range radio signal to cause traffic lights to flash thereby altering nearby vehicles and pedestrians. These methods do not alert a pedestrian who is, for example, reading a text message while walking (a common habit in smart phone users). Another negative is that it also requires modification to public infrastructure (traffic signals) on a large scale.

It is an aspect of the prior art to overcome or ameliorate a problem of the prior art by providing systems to warn an individual who is distracted or functionally hearing impaired by an audio signal (such as music through headphones or a car sound system) to a potential traffic hazard in their immediate environment. It is a further aspect to provide an alternative to prior art warning systems.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### BRIEF DESCRIPTION OF THE DRAWINGS

FIG. 1 is a diagram showing operation of the present systems in a real world situation.

FIG. 2 shows circuit diagrams of a radio transmission device of the present invention incorporated into a horn circuit of a car.

FIG. 3 is a block diagram showing the hardware and software components of a smart phone capable of receiving a warning signal from a radio transmission device.

### SUMMARY OF THE INVENTION

In a first aspect the present invention provides a system for warning an individual of a potential traffic hazard, the system comprising:
radio signal transmission means configured to transmit a warning signal,
radio signal receiving means configured to receive the warning signal,
(a) sound transduction means configured to deliver audio to the individual, and sound altering means configured to alter the audio delivered to the individual, and/or
(b) visual media display means configured to deliver a visual medium to the individual, and visual media altering means configured to alter the visual media delivered to the individual, and/or
(c) tactile stimulus means configured to deliver a tactile stimulus to the individual
   wherein upon reception of the warning signal by the radio signal receiving means,
(i) the sound altering means alters the audio played to the individual such that the individual is made aware of the traffic hazard, and/or
(ii) the visual media display means alters the visual media displayed to the individual such that the individual is made aware of the traffic hazard, and/or
(iii) the tactile stimulus means delivers a tactile stimulus such that the individual is made aware of the traffic hazard,

In one embodiment, the radio signal transmission means is mounted on or about a vehicle that is a potential traffic hazard to the individual.

In one embodiment, the radio signal transmission means is actuated to transmit the warning signal by actuation of a warning device on or about the vehicle.

In one embodiment, the warning device on or about the vehicle emits an audible warning.

In one embodiment, the radio signal transmission means is a short range radio transmission. means,

In one embodiment, the radio signal transmission means is operable over a range of less than about 100 metres, or about 50 metres, or about 10 metres.

In one embodiment, the radio signal transmission means is a Bluetooth™ radio transmitter.

In one embodiment, the radio signal receiving means is comprised within
(a) an audio device, optionally selected from the group consisting of a personal audio device, a vehicle-mounted audio device, a cell phone, a smart phone, and a headphone, and/or
(b) a visual media device, optionally selected from the group consisting of a personal video device, a personal game console, a cell phone, a smart phone, a vehicle mounted information display system, and a vehicle mounted navigation system, an e-Book reader, and an optical head-mounted display, and/or
(c) a vibratory device, optionally selected from the group consisting of a cell phone, a portable computer game console a smart phone, and a pager.

In one embodiment, the audio device and/or visual media device and/or tactile vibratory device is Bluetooth™-enabled.

In one embodiment the sound transduction means is a speaker and/or the visual media display means is a processor-driven visual media display unit and/or the tactile stimulus means is a vibratory means.

In one embodiment the sound altering means and/or the visual media display means and/or tactile stimulus means is/are controllable by software.

In one embodiment the software is executable by a processor of a device comprising the sound altering means and/or the visual media display means and/or tactile stimulus means.

In one embodiment the software is embodied in the form of a smart phone app.

In one embodiment the sound altering means mixes a warning sound with the output of the sound transduction means, and/or the visual media display means mixes a warning visual with the output of the visual media display means, and/or tactile stimulus means vibrates.

In a second aspect the present invention provides radio signal transmission means configured to transmit a warning signal to an individual, the transmission means mounted on or about a vehicle that is a potential traffic hazard to the individual.

In one embodiment, the radio signal transmission means is configured to transmit the warning signal by actuation of a warning device on or about the vehicle.

In one embodiment the warning device on or about the vehicle emits an audible warning.

In one embodiment the radio signal transmission means is a short range radio transmission means.

In one embodiment the radio signal transmission means is operable over a range of es than about 100 metres, or about 50 metres, or about 10 metres.

In one embodiment the radio signal transmission means is a Bluetooth™ radio transmitter.

In a third aspect the present invention provides processor-executable instructions configured to alter the output of an audio device in response to a radio warning signal, and/or alter the output of a visual media device, and/or alter the output of a vibratory device in response to reception of a radio warning signal.

In one embodiment the processor-executable instructions are executable by a mobile processor.

In a fourth aspect the present invention provides an audio device and/or visual media device and/or vibratory device having memory comprising the processor-executable instructions as described herein.

In one embodiment the audio device is selected from the group consisting of a personal audio device, a vehicle-mounted audio device, a cell phone, a smart phone, and a headphone.

In one embodiment the visual media device is selected from the group consisting of a personal video device, a personal game console, an e-book reader, a cell phone, a smart phone, a vehicle mounted information display system, and a vehicle mounted navigation system, an e-Book reader and an optical head-mounted display.

In one embodiment the vibratory device is selected from the group consisting of a cell phone, a smart phone, a portable computer game console and a pager.

### DETAILED DESCRIPTION OF THE INVENTION

After considering this description it will be apparent to one skilled in the art how the invention is implemented in various alternative embodiments and alternative applications. However, although various embodiments of the present invention will be described herein, it is understood that these embodiments are presented by way of example only, and not limitation. As such, this description of various alternative embodiments should not be construed to limit the scope or breadth of the present invention. Furthermore, statements of advantages or other aspects apply to specific exemplary embodiments, and not necessarily to all embodiments covered by the claims.

Throughout the description and the claims of this specification the word “comprise” and variations of the word, such as “comprising” and “comprises” is not intended to exclude other additives, components, integers or steps.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may.

The present invention is predicted on the discovery that radio signals (and particularly short range radio signals) are useful in communicating a warning signal to an individual who is (i) listening to audio in the form of music, speech, video game sounds and the like, and/or (ii) viewing visual media in the form of text, video, graphics, photographs and the like. The systems of the present invention require that upon reception of a radio signal, (i) the audio being listened to is altered in some way such that the individual comprehends that a potential traffic hazard in his or her immediate environment and/or (ii) the visual media being viewed is altered in some way such that the individual comprehends that a potential traffic hazard in his or her immediate environment. This results in interruption to the audio or visual medium only when there is a hazard, and not on a continuous basis. This method is also effective where the individual is not visually engaged with his/her surroundings, such as when reading a text message or playing a computer game.

A tactile stimulus (such as a vibration) may also be communicated to the individual as warning of a traffic hazard.

As used herein, the term “traffic hazard” is intended to mean an actual, predicted, likely, possible or perceived traffic hazard. The hazard may or may not be a serious of life-threatening hazard, and may even be just be the type of hazard requiring a casual notice to another person to take care in or about traffic, or to be more aware of the surrounding traffic.

The individual subject of the present systems may be any person requiring warning of a traffic hazard, and may or may not be actually on a road when the systems provides the warning. Pedestrians often require warning before stepping onto a road. Drivers frequently scan areas abutting roads when driving, especially in areas with significant pedestrian traffic (such as shopping strips) and often notice individuals not concentrating and about to step onto a road into the path of traffic. The individual may also be a driver or a rider of a vehicle distracted by, or functionally hearing impaired by, their use of an audio device such as a car stereo, headphones, smart phone and the like, or a visual media device such as a portable games console, iPOD™ device, smart phone, e-Book reader and the like.

The alteration in audio provided by the present systems may be more noticeable than prior art methods that filter and mix in ambient sounds (such as car horns) into the audio. For example, audio delivered to the individual may be completely stopped, forcing the user to look around and listen. The audio may be mixed with a warning sound (and optionally at very high volume) such as a reproduced car horn sound, or a screeching tyre sound or any other sound that will gain the attention of the individual.

The radio transmission means is integral to the present systems, being required to transmit a warning signal in an appropriate situation. The transmission means may be mounted on or about a vehicle. In this way, a pedestrian may be alerted to an impending collision with an oncoming vehicle, where that vehicle is fitted with a radio transmission means according to the present systems. The radio warning signal emits from the vehicle thereby creating a moveable warning zone surrounding the vehicle as it travels.

As used herein, the term “Vehicle” is not to be construed narrowly and is intended to include a car, a motorcycle, a truck, an emergency vehicle, a bicycle, a bus, a tram, a train, a golf cart, a mobility scooter, a tractor, a vessel et cetera.

When mounted on a vehicle, the radio transmission means may be positioned in an area of the vehicle which will minimise interference to, or attenuation of, the radio transmission. Suitable areas of a car may be the dashboard, or the forward portion of the engine bay. Given the benefit of the present specification, the skilled person is able to conceive and trial other areas of a vehicle by way of routine experimentation only.

When mounted about a vehicle, the radio transmission means may not be mounted physically on the vehicle per se, but on a substrate upon which a vehicle may travel or in an area through which the vehicle travels. For example, the radio transmission means may be mounted proximal to a train level crossing such that a warning signal (however actuated) emits from the transmission means to all vehicles approaching the crossing. A magnetic sensor in the track or a light sensor directed across the track may be used to trigger the radio transmission means. Alternatively, the radio transmission means may be responsive to the sound frequencies of a train horn, emitting a warning signal when the train approaches a level crossing and (as required) sounds its horn.

The transmission of the warning signal may be triggered by any advantageous or convenient means. In one embodiment, the signal is triggered by a dedicated switch or button disposed in the interior of the vehicle, and easily accessible by the driver. Thus, where the driver becomes aware of a pedestrian in proximity and considers that the pedestrian is unaware of his/her vehicle, then he/she may actuate the dedicated switch or button. This causes the radio signal transmission means to transmit a warning signal to the surrounding environment.

Reception of the warning signal by the radio signal receiving means (disposed on the pedestrian) thereby causing the audio track being played on the pedestrian's portable music player to be altered in some way so as to communicate a warning. For example, the alteration may be the superimposition of an artificial car horn sound on the audio track.

Where the individual is reading a book a on an e-Book reader device, the screen may flash, for example, to alert the individual. It will be appreciated that many devices are capable of playing audio and video media in which case the alteration may be in either or both of these media.

Where the individual is playing a computer game, the console may vibrate. Vibration is also a potential warning means available with cell phones, smart phones, pagers and the like.

In a preferred embodiment, the radio signal transmission means is actuated by an existing warning device of the vehicle, and typically a warning device that emits an audible warning. This embodiment is particularly advantageous because the radio transmission means is activated without the need for a dedicated action by a driver. Where the transmission means is fitted to a car, the horn circuit may be used for actuation. Thus, where the driver considers that a collision with a pedestrian is likely he/she will actuate the horn (often by reflex). Given that the pedestrian may be listening to music through headphones, the horn will not be heard. However, by the present systems the sound of the horn is replaced by the secondary warning given by way of alteration to the music track being played.

Other audible warnings that may be exploited by the present methods include a train horn, a tram bell, a train level crossing bell, a bicycle bell, an emergency vehicle siren, a ferry horn et cetera.

The present systems may be particularly suitable where the radio transmission means is mounted on a bicycle, allowing the rider to warn a pedestrian of their approach. Bike paths are often shared with pedestrian traffic, with cyclists often needing to alert pedestrians when approaching from behind. Warning pedestrians using a bell is generally ineffective where the pedestrian is wearing headphones, and so collisions are not uncommon. Given the potential for injury to the rider (which is considerably higher than for a driver of a car), the present systems provide particular advantages for cyclists. Motorcycles are also particularly advantaged given the propensity for the rider to come off the machine in a collision with a pedestrian.

The present systems may also be implemented to warn a car driver who is listening to music at very high volumes (via car stereo speakers or headphones) of an approaching emergency vehicle. While sirens are intended to be audible inside a car, very loud music can easily mask the sound. The present systems may also warn a driver who is otherwise distracted by a telephone call or music playing at a low volume.

Watercraft such as commuter ferries also emit audible warnings when approaching a dock where passengers are positioned too close to the edge of the dock. Many commuters wear headphones when making the routine trip to and from work, and may not hear an approaching ferry.

In one embodiment, the alteration in the audio played to the individual comprises the superimposition of the audible warning over the audio. Thus, the individual will immediately recognise whether a warning has been emitted from a car, a truck, a motorcycle, a bicycle or a train given that each type of vehicle is associated with a unique warning sound.

It is contemplated that the present systems are operable using other vehicle features as a means to actuate the transmission means. For example, the hard application of brakes is associated with a potentially dangerous traffic situation, and could be used to trigger the warning signal. Another may be the activation of a seat belt pre-tensioning system.

The radio transmission means is some embodiments may be actuated automatically by a proximity sensor of a car, which may operate by radar, video, infrared, ultrasonic or other technologies. The sensors are typically incorporated into a car for parking assistance or in collision avoidance systems. For example, where a first car is travelling at speed and a second car is deemed too close (by the first car baking suddenly, or the second car “tail gating”) a rear sensor on the first car actuates the radio transmission means of the first car to emit a warning signal which is received by the stereo system of the second car. An audible warning is given by the stereo system of the second car, and so the driver of the second car (who may have been distracted while listening to music) is immediately roused to take any necessary evasive action.

The warning signal transmitted by the radio signal transmission means may be any type considered useful by the skilled person for a given application. Because of the intention of the present systems to essentially replace an audible warning with a radio-based warning, the transmission means may have a range equivalent to that to that of an audible vehicle warning device (such as a car horn), and typically therefore have a short transmission range. Moreover, it is preferred that the radio transmission means is capable of transmitting a signal according to a common specification or protocol to ensure compatibility of the present systems with a large number of existing consumer devices.

In consideration of the foregoing, Applicant has discovered that radio transmission means based on the well known Bluetooth™ protocol are highly advantageous. A significant advantage of the Bluetooth™ protocol is that many personal portable audio devices (such as smart phones, car stereos, and even some headphones) are Bluetooth™-enabled thereby negating the need for dedicated hardware to be used in the present systems. The relatively short range of Bluetooth™ signals is also very well suited to the present systems, and indeed may be varied by the use of Class 1 devices (100 mW, 20 dBm, typical range of 100 metres), Class 2 devices (2.5 mW, 4 dBm, typical range of about 10 meters). An advantage of short range transmission means (including Bluetooth™) is that the warning signal does not extend to individuals not in any immediate danger from the traffic hazard. Accordingly, the audio or visual media being played to individuals who are not in any danger is not interrupted.

There are other advantages to Bluetooth™ such as the low cost of hardware, no requirement for a telecommunication license, and the availability of development platforms (include software development platforms).

The skilled person is familiar with the various available hardware devices for the transmission of Bluetooth™ signals. As one example, Texas Instruments (TX, USA) supplies a range of modules that are potentially applicable to the present systems, including the CC2560 (Bluetooth™), LMX9838 (Simply Blue) and CC2564 (Bluetooth™+ BLE), WL1271 (singlechip WLAN/Bluetooth™ device) and CC2564 (Bluetooth™/Bluetooth™ low energy or Bluetooth™/ANT) devices. The use of so called “Dual Mode” Bluetooth™ modules is also contemplated to communicate with mobile phones and tablets. In the market today, some devices have dual mode (Bluetooth™ and BLE) and other have only Bluetooth™.

The use of a Dual Mode module allows the present systems to be operable with devices through Bluetooth™, BLE or both.

Low energy Bluetooth™ modules are particularly preferred, especially for applications where battery power is relied upon.

As understood by the skilled person, many Bluetooth™ modules broadcast the following information:
UUID (Universally Unique Identifier) this is a totally unique ID for every beacon in the world. (16 bytes)
Company ID; this code identifies the manufacturer of the beacon, this number is administered by Bluetooth.org (2 bytes)
Major ID code; Manufacturer set code to identify different blue tooth hardware (2 bytes)
Minor ID code; This is a sub ID code to the major code (2 bytes)

When a software application (such as a smart phone app of the present system) intercepts a Bluetooth™ beacon, the application typically queries a central database using the UUID and then executes a required function. The software application may therefore require constant access to such a central database to verify the UUID, this access being achievable, for example, by onboard storage of the database (or portions thereof) or by way of wireless network connection to a remote database.

To avoid the need for UUID database access, the operator of the present system may procure their own Company ID (via www.bluetooth.org) such that if the smart phone app encounters that Company ID the app identifies the beacon as part of the present waring system and (this being regardless of the UUID transmitted), and accordingly there is no need to verify its identity.

Given the presence of many Bluetooth™ beacons in metropolitan areas, rather than the UUID being utilized as the main identifying code, the unique Company ID of the warning system operator may be used. Some Bluetooth™ modules do not allow the Company ID to be changed, with such modules being unsuitable for embodiments which rely on a Company ID for identification.

As an alternative to Bluetooth™, the newer ANT/ANT+ radio transmission means may be used in the present systems. Over 18 million mobile devices are presently ANT/ANT+ enabled. ANT/ANT+ utilizes a simple protocol (which is sufficient for the present systems) and has a range equivalent to that of BlueTooth™ Low Energy (about 50 meters).

It is also contemplated that WiFi may be a useful protocol according to the present systems. The vast majority of smart phones and tablets are WiFi-enabled, and the range is controllable by modulation of power settings.

Alternatives to BlueTooth™, ANT/ANT+ and WiFi will undoubtedly be developed in the future, with functional equivalents being included in the ambit of the present invention. It is well within the knowledge and expertise of the skilled person to trial any putative functional equivalent for applicability to the present systems, and moreover to effect any modifications required for operability.

It is desirable that security features of any wireless transmission protocol used in the present methods do not compromise the ability for a radio warning signal to be instantly received and processed to provide a warning to the individual. To that end, in some embodiments the warning signal may simply be the transmission of the name of the radio transmission means, or any other information that is routinely broadcast to allow a receiving device to decide whether or not to exchange data.

For example, Bluetooth™ devices typically transmit the following information: device name, device class, list of services, and technical information such as device features, manufacturer, Bluetooth™ specification used, and clock offset. If the device name is predetermined to be “TRAFFIC WARNING” for example, and a smart phone is configured to indentify and act on the detection of any device having the name “TRAFFIC WARNING”, then the mere detection of the so-named device may trigger a car horn being played to the individual having the smart phone. In this embodiment, an actual connection between two devices is not required, this providing significant security advantages.

The Bluetooth™ device may be configured to only broadcast the device name when the horn (for example) is actuated. Alternatively, the device may continuously broadcast the name, but maintain the antenna in a disconnected state (optionally by a simple relay) until the horn is actuated in which case the antenna is reconnected so that the device name is immediately transmitted.

By the above embodiments, it is not necessary for a smart phone user to leave their Bluetooth™ connection unsecured, or to open the connection in order to participate in the present methods. Nor is there any time delay in any pairing or bonding that may be required to establish a Bluetooth™ connection.

In some embodiments, dedicated software on the smart phone may allow for direct access to the Bluetooth™ module thereby bypassing any security. The software may be configured to allow only for the reception of Bluetooth™ signals (and possibly only signals secretly coded), and may not allow for any transmission of data from the smart phone thereby protecting stored information.

Where any of the above methodologies are undesirable or inoperable, it is nevertheless possible to ensure a rapid Bluetooth™ connection is made without user input (or minimal user input) using various pairing and bonding strategies which can allow for Bluetooth™ devices to be able to establish a connection without user intervention (for example, as soon as they are in range).

In one embodiment, the pairing mechanism is a secure simple pairing mechanism (SSP), and preferably the “just works” mechanism. As implied by the name, no user interaction is required. This method is typically used by headsets with very limited IO capabilities but may be adapted to the present systems for use with other devices.

In one embodiment, to prevent any delays in transmitting a warning signal, a vehicle may make Bluetooth™ connections with every Bluetooth™-enabled device within range. As the vehicle travels, new connections made and existing connections are terminated.

The sound transduction means of the present system is typically associated with a personal music player or smart phone (such as a headphone or earphone), but may be a car stereo speaker. All the aforementioned means are capable of masking a proximal audible warning signal and thereby present a danger to the listener. In some embodiments, the sound transduction means does not mask a proximal audible warning, but instead causes distraction of an individual. For example, a discussion on a cell phone may not mask an audible warning but because the attention of the individual is diverted away from his/her surroundings a danger is nevertheless caused.

The sound altering means may be any means capable of causing a discernible or comprehensible alteration in the audio delivered to the individual by the sound transduction means. The alteration may be in volume or tone, this being achievable by the simple modulation of audio signal from the sound transduction means, or by the control of an amplifier or mixer operably connected to the sound transduction means. The alteration may be more complex and involve the superimposition of a sound over the audio played to the individual. The superimposed sound may be fixed (such as the sound of a car horn) or may be selected by the individual and/or person controlling the radio signal transmission means.

The visual media display means is typically associated with a person video device such as a portable game console, a cell phone, a vehicle mounted information system (for example an LCD display showing data such as engine revolution rate, fuel level, speed, temperature etc), a navigation system (such as a Tom Tom™ GPS display), an e-Book reader (such as a Kindle™), or an optical head-mounted display (such as Google glass™.)

The visual media alteration means may be any means capable of causing a discernible or comprehensible alteration in the visual medium delivered to the individual by the visual media display means. The alteration may be in colour or intensity, this being achieved by the simple modulation of colour saturation or brightness of a screen. The alteration may be more complex and involve the superimposition of a visual over the visual medium being played to the individual. The superimposed visual may be fixed (such as a graphic of a STOP sign) or may be selected by the individual and/or person controlling the radio signal transmission means

The system may be configured such that the person controlling the radio signal transmission means may be allowed to impart a customized warning to the individual. In some instances a very urgent warning may be given (such as a long horn blast, or the intense flashing of a video screen), for example where the individual is about to step out in front of the vehicle having the radio transmission means. Alternatively, a more gentle warning (for example a “beep-beep” sound, or alteration of a video from colour to monochrome) may be given. More gentle warnings will be appropriate where urgent evasive action is not required, for example where a cyclist is riding outside of a bicycle lane, and the driver of a car wishes to pass. In such configurations, some co-design may be required in the transmission means and receiving means (or software/hardware connected to those means) such that the individual receives the intended warning message.

The sound altering means or visual media altering means may be hardware-based, software-based or a combination of both.

Software-based implementations are preferred given the widespread use of smart phones and iPOD™-type devices amongst many populations, such devices having significant processing power at hand. The processor may control the radio signal receiving means and also the sound or visual media altering means, such that a software application may detect reception of a warning signal and also effect the alteration in the audio or video played to the listener. The skilled person is familiar with mobile application development executable on an iOS™, Android™ or other suitable operating system.

Where a processor is not available, hardware-based means may nevertheless be useful. As a basic example, reception of the radio warning signal may simply cut the audio or video played to the individual thereby alerting to the potential traffic hazard.

The present invention further provides a hardware device capable of transmitting a warning signal to warn an individual of a traffic hazard. The device comprises a radio signal transmission means. For the sake of clarity and brevity, the various features and optional features of the radio transmission means recited elsewhere herein will not be repeated at this point of the specification, but are nevertheless incorporated.

The radio signal transmission means may be configured to be easily retrofitted to an existing vehicle. For example, where the transmission means is triggered by a car horn to emit a warning signal, the transmission means may be incorporated within or about a horn relay. In this way, the process of retrofitting includes the steps of removing the existing relay and simply replacing with a modified relay comprising radio transmission means.

Alternatively, the radio transmission means may be operably connected to an adaptor which has a male portion (to insert into the relay socket of the car) and a female portion (to receive the existing relay). The adaptor thereby shares the electrical connections of the existing relay with the radio transmission means.

It is contemplated that where the radio transmission means requires power significantly higher or lower than 12 Volts, a voltage regulator may be disposed at an appropriate point of the circuit.

A further aspect of the present invention provides software operable in the context of the present systems, and configured to alter the sound emitted by the sound transduction means in response to receipt of a warning signal. The software is typically resident on a smart phone, and is capable of controlling a radio module of the phone, a digital/analogue converter of the phone, or an audio mixer/amplifier of the smart phone. For example, the software may be capable of turning on a Bluetooth™ service, configuring Bluetooth™ to automatically receive any connection (i.e. without regard to any security issue), assess the device name or any other information which is routinely transmitted by a Bluetooth™ device and the like.

In response to receipt of a warning signal, the software may be capable of modulating the volume or tone of digital music file being played, or to superimpose another sound (such as a car horn) over the digital music file.

The computer-related systems described herein are, in one embodiment, performable by one or mare processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components.

The term memory unit as used herein, if clear from the context and unless explicitly stated otherwise, also encompasses a storage system such as a disk drive unit or solid state storage device.

The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated.

The software may reside in the hard disk, hard drive, memory stick, flash memory card or like device, or may also reside, completely or at least partially, within the RAM and/or within the processor during execution thereof by the computer system. Thus, the memory and the, processor also constitute computer-readable carrier medium carrying computer-readable code.

Furthermore, a computer-readable carrier medium may form, or be included in a computer software product.

Note that while descriptions and diagrams may only refer to a single processor and a single memory that carries the computer-readable code, those in the art will understand that many of the components described above are included, but not explicitly shown or described in order not to obscure the inventive aspect.

The present systems may comprise a computer-readable carrier medium carrying a set of instructions, e.g., a computer program that is for execution on one or more processors, e.g., one or more processors. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

It should be appreciated that in the above description of exemplary embodiments of the invention, various features of the invention are sometimes grouped together in a single embodiment, figure, or description thereof, for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

The present invention will now be more fully described by reference to the following non-limiting preferred embodiments.

### PREFERRED EMBODIMENTS OF THE INVENTION

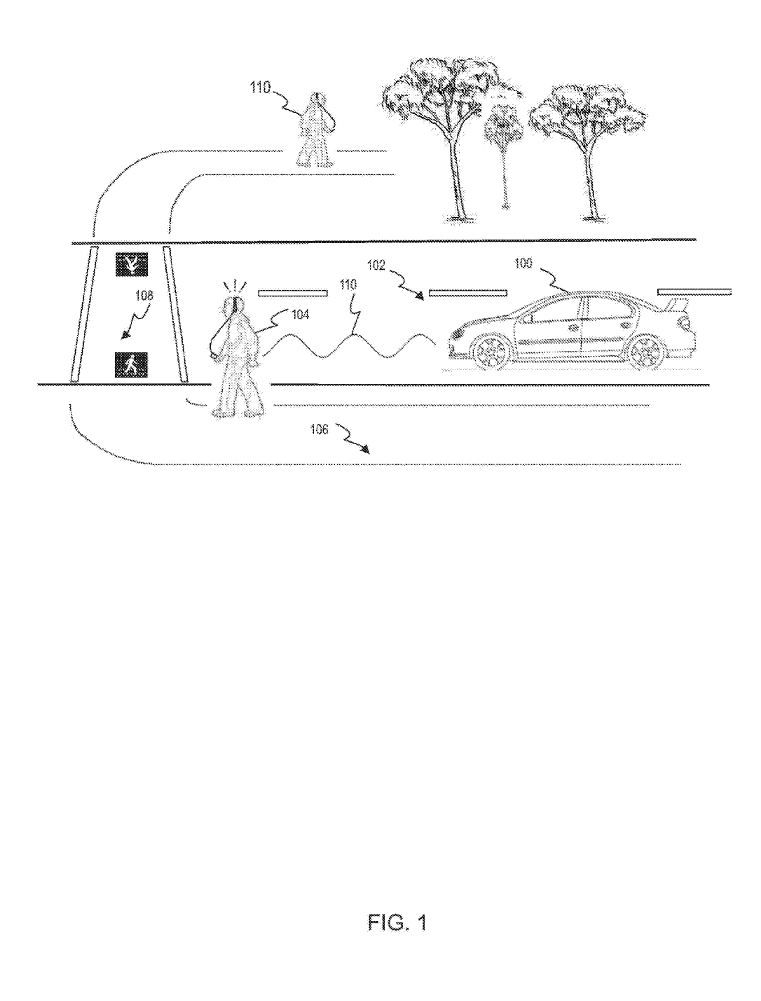

Turning now to FIG. 1 there is shown a preferred embodiment of the present system in operation whereby a pedestrian 104 is walking along a path 106, the pedestrian listening to music through headphones connected to a smart phone. The pedestrian 104 is about to cross the road 102 at the crossing point 108 but is unaware of the car 100 driving towards him. The driver of the car 102 considers it likely that the pedestrian 104 is unaware of his approaching car and sounds the horn. The pedestrian 104 is unable to hear the car horn. However, upon activation of the car horn, a Bluetooth™ module transmits a radio signal the short distance to the pedestrian's smart phone. The audio played to the user is altered to superimpose a horn sound over the music, and the pedestrian immediately stops to visually survey the surrounding traffic. Upon noting the oncoming car 100, he waits for it to pass before crossing the road 102. The short range of the Bluetooth™ radio signal 110 means that a second pedestrian 110 some distance away and in no potential danger is not reachable by the signal, and is there able to listen to unaltered audio.

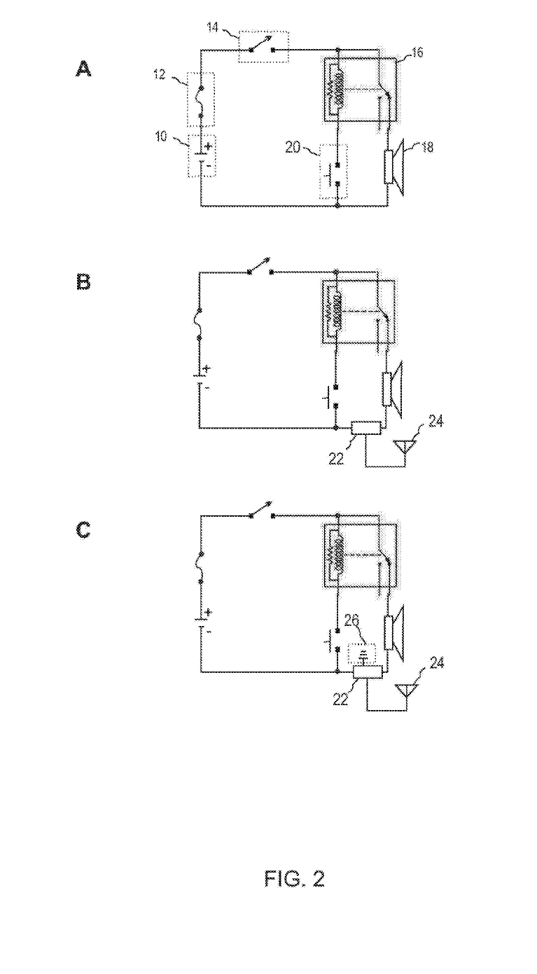

In FIG. 2 there are shown circuit diagrams for the incorporation of a Bluetooth™ transmission module (or indeed any other radio module) into an automotive horn circuit. Panel A shows an existing (unmodified) horn circuit having a 12 volt battery 10, fuse 12, ignition switch 14, horn relay 16, horn 18, and momentary horn switch 20.

Panel B shows the horn circuit of Panel A showing a Bluetooth™ module 22 wired in series with the horn. Thus, when the horn button 20 is actuated, the module 22 is powered and automatically emits the warning signal via the antenna 24.

Panel C shows the horn circuit of Panel B, but with the module 22 being continuously grounded 26 (and therefore powered) so long as the ignition switch is in the “ON” position. The module is triggered to emit the warning system by closing of the horn switch. This embodiment negates any delay in emitting the warning signal by the powering-up process of the module.

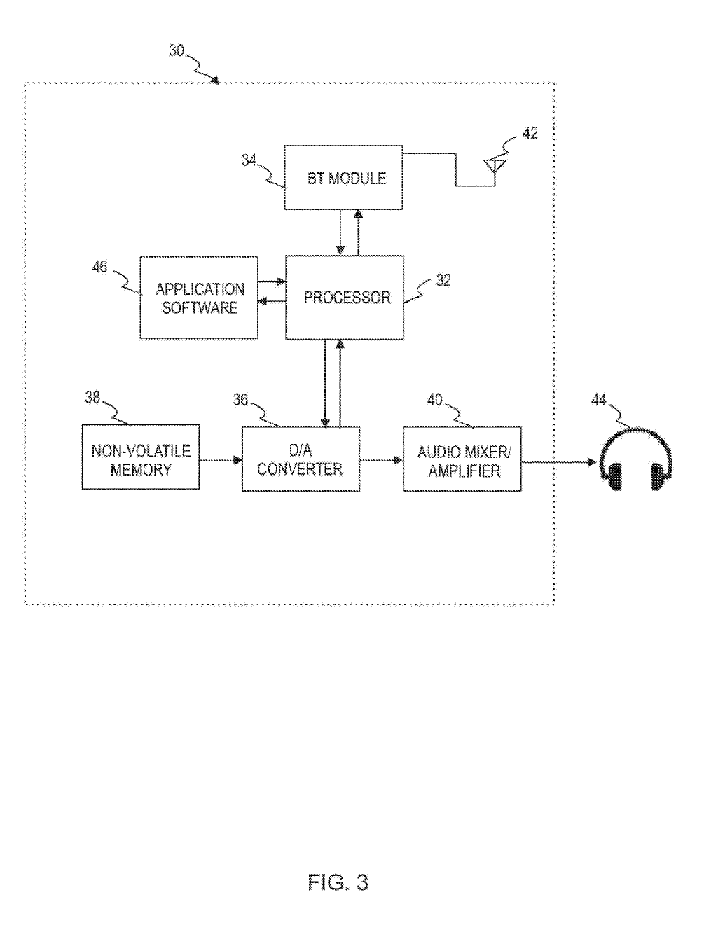

FIG. 3 shows the interaction of various hardware and software components of a smart phone 30, including a processor 32 (being the main processor of the smart phone), the Bluetooth™ module 34, digital/analogue sound converter 36, non-volatile memory 38, audio mixer and amplifier 40, and antenna 42 each of 32, 34, 36, 38, 40, and 42 being already existing in the smart phone. The headphones 44 are plugged into the smart phone 30 by the user.

The application software 46 is stored in volatile memory (RAM) for execution by the processor 32. The application software 46 is dedicated to operability of the present systems and is loaded into the smart phone as an “app” by the user.

In use, the Bluetooth™ module is “ON” and able to receive a warning signal from a radio transmission means of the present system by way of the antenna 42. The non-volatile memory 38 stores a digital music file which is converted into an analogue sound signal by the D/A converter 36. The analogue signal is processed by the amplifier/mixer 40 and transmitted to the headphones 44. Reception of a warning signal (as identified by the application software 46) causes the application software 46 to pass a digital sound file of a car horn to the D/A converter 36, the horn sound being amplified and mixed with the music audio signal such that the music and horn sound are transmitted to the headphones 44.

1. A system for warning an individual of a potential traffic hazard, the system comprising:
radio signal transmission means configured to transmit a warning signal,
radio signal receiving means configured to receive the warning signal, and any one or more of (a), (b) and (c) as follows:
(a) sound transduction means configured to deliver audio to the individual, and sound altering means configured to alter the audio delivered to the individual, wherein upon reception of the warning signal by the radio signal receiving means, the sound altering means alters the audio played to the individual such that the individual is made aware of the traffic hazard,
(b) visual media display means configured to deliver a visual medium to the individual, and visual media altering means configured to alter the visual medium delivered to the individual, wherein upon reception of the warning signal by the radio signal receiving means, the visual media display means alters the visual displayed to the individual such that the individual is made aware of the traffic hazard,
(c) tactile stimulus means configured to deliver a tactile stimulus to the individual, wherein upon reception of the warning signal by the radio signal receiving means, the tactile stimulus means delivers a tactile stimulus such that the individual is made aware of the traffic hazard.

2. The system of claim 1 wherein the radio signal transmission means is mounted on or about a vehicle that is a potential traffic hazard to the individual.

3. The system of claim 1 wherein the radio signal transmission means is actuated to transmit the warning signal by actuation of a warning device on or about a vehicle that is a potential traffic hazard to the individual.

4. The system of claim 3 wherein the warning device on or about the vehicle emits an audible warning.

5. The system of claim 1 wherein the radio signal transmission means is a short range radio transmission means.

6. The system of claim 1 wherein the radio signal transmission means is operable over a range of less than about 100 metres, or about 50 metres, or about 10 metres.

7. The system of claim 1 wherein the radio signal transmission means is a Bluetooth™ radio transmitter.

8. The system of claim 1 wherein the radio signal receiving means is comprised within at least one of:
(a) an audio device, selected from the group consisting of a personal audio device, a vehicle-mounted audio device, a cell phone, a smart phone, and a headphone,
(b) a visual media device, selected from the group consisting of a personal video device, a personal game console, a cell phone, a smart phone, a vehicle mounted information display system, and a vehicle mounted navigation system, an e-Book reader, and an optical head-mounted display, or
(c) a vibratory device, selected from the group consisting of a cell phone, a portable computer game console a smart phone, and a pager.

9. The system of claim 8 wherein at least one of the audio device, visual media device or tactile vibratory device is Bluetooth™-enabled.

10. The system of claim 1 wherein the sound transduction means is a speaker and/or the visual media display means is a processor-driven visual media display unit and/or the tactile stimulus means is a vibratory means.

11. The system of claim 1 wherein the sound altering means and/or the visual media display means and/or tactile stimulus means is/are controllable by software.

12. The system of claim 11 wherein the software is executable by a processor of a device comprising the sound altering means and/or the visual media display means and/or tactile stimulus means.

13. The system of claim 12 wherein the software is embodied in the form of a smart phone app.

14. The system of claim 1 wherein the sound altering means mixes a warning sound with the output of the sound transduction means, and/or the visual media display means mixes a warning visual with the output of the visual media display means, and/or tactile stimulus means vibrates.

15. Radio signal transmission means configured to transmit a warning signal to an individual, the transmission means mounted on or about a vehicle that is a potential traffic hazard to the individual.

16. The radio signal transmission means of claim 15 configured to transmit the warning signal by actuation of a warning device on or about the vehicle.

17. The radio signal transmission means of claim 16 wherein the warning device on or about the vehicle emits an audible warning.

18. The radio signal transmission means of claim 15 wherein the radio signal transmission means comprises a short range radio transmission means.

19. The radio signal transmission means of claim 15 wherein the radio signal transmission means is operable over a range of less than about 100 metres, or about 50 metres, or about 10 metres.

20. The radio signal transmission means of claim 15 wherein the radio signal transmission means is a Bluetooth™ radio transmitter.

21. (canceled)
